(19) United States
(12) Patent Application Publication
(10) Pub. No.: US 2004/0191673 A1
(43) Pub. Date: Sep. 30, 2004

(54) Lithographic printing plate precursor and method for preparation thereof

(75) Inventor: Kaku Sakata, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/805,261

(22) Filed: Mar. 22, 2004

(30) Foreign Application Priority Data
Mar. 26, 2003 (JP) P.2003-086022

(51) Int. Cl. G03C 1/76

(52) U.S. Cl. 430/270.1

(57) ABSTRACT

A lithographic printing plate precursor comprising a hydrophilic support having provided thereon a first layer comprising a first resin that is water-insoluble and alkali-soluble and a second layer comprising a second resin that is water-insoluble and alkali-soluble in this order and a light-heat converting agent incorporated into at least one layer of the first layer and second layer, which further comprises at least one organic solvent selected from organic solvents having a boiling point not less than 150° C. and a dipole moment not less than 3.50 debye in an amount of from 0.5 to 5% by weight based on the total dry weight of the first layer and second layer.

### FIELD OF THE INVENTION

The present invention relates to a lithographic printing plate precursor suitable for use as an offset printing master and a method of the preparation thereof. More particularly, it relates to a lithographic printing plate precursor for a so-called direct plate-making with an infrared laser, which is capable of producing a printing plate directly from digital signals of a computer or the like and a method for the preparation thereof.

### BACKGROUND OF THE INVENTION

Thee progress of lasers in recent years has been remarkable and high output and compact devices of solid laser or semiconductor laser having a light emission region in the range of from near infrared to infrared are easily available. These lasers are very useful as a light source for exposure in conducting the direct plate-making from digital data of a computer or the like in the field of lithographic printing.

In conventionally known positive-working lithographic printing plate precursors for direct plate-making with an infrared laser, resins that are soluble in an aqueous alkali solution and have phenolic hydroxy groups, for example, novolak resins are used. For instance, an image-forming material comprising a substance that absorbs light to generate heat and a variety of onium salts, quinonediazide compounds or the likes incorporated into a resin soluble in an aqueous alkali solution and having phenolic hydroxy groups, for example, a novolak resin is proposed in Patent Document 1 (JP-A-7-285275 (the term “JP-A” as used herein means an “unexamined published Japanese patent application”)). In such an image-forming material, the onium salt, quinonediazide compound or the like functions as a dissolution inhibiting agent for the resin soluble in an aqueous alkali solution in the image area and on the other hand, it is decomposed by heat and loses its dissolution inhibiting ability in the non-image area so that the non-image area becomes removable upon development, whereby an image is formed. Such an image-forming material is disadvantageous in that handling of the material is restricted under a yellow light because the onium salt, quinonediazide compound or the like has a light absorption region (from 350 to 500 nm) in a visible light range. Further, the onium salt, quinonediazide compound or the like does not have necessarily good compatibility with a polymer compound soluble in an aqueous alkali solution and a substance that absorbs light to generate heat, and it is difficult to prepare a uniform coating solution containing these compositions. Therefore, there is a problem in that a uniform and stable image-forming material can be hardly obtained.

Also, there is a case wherein image formation is performed with a novolak resin or the like without using a photosensitive compound as described, for example, in Patent Document 2 (JP-B-46-27919 (the term “JP-B” as used herein means an “examined Japanese patent publication”)). However, such a case has problems in that printing durability is degraded by the use of cleaner or the like and in that printing with UV ink cannot be conducted, because the novolak resin per se is poor in solvent resistance. Further, there is a problem in that development latitude is extremely poor when the novolak resin is used in the absence of photosensitive compound.

In order to overcome the problems described above, a photosensitive material comprising a photosensitive layer of two-layered structure in which a copolymer containing a monomer having a specific structure, for example, a sulfonamimdo group or an active imino group is used in a layer close to a support and a positive-working image-forming layer composed of a novolak resin is provided as a surface layer is proposed in Patent Document 3 (JP-A-11-218914.

However, such a specific binder has extremely high solvent resistance in order to maintain cleaner resistance and resistance to UV ink and as a result there is a problem in that a handling property at the production is poor since an extremely long time is required for dissolving the binder at the time of preparation of a coating solution for the production of photosensitive material.

Moreover, a lithographic printing plate precursor is illustrated in Patent Document 4 (JP-A-2001-255645) in which an amount of remaining solvent in a photosensitive layer is controlled not more than 5% by weight in order to improve preservation stability of a photosensitive material. However, since the remaining solvent in a photosensitive layer originally has a function to aid permeability of developer and solubility at the time of alkali development, the reduction in the amount of remaining solvent to 5% by weight or less causes a problem of the occurrence of residual color after development of the photosensitive material and the decrease in sensitivity.

Patent Document 1: JP-A-7-285275

Patent Document 2: JP-B-46-27919

Patent Document 3: JP-A-11-218914

Patent Document 4: JP-A-2001-255645

### SUMMARY OF THE INVENTION

Therefore, an object of the invention is to provide a positive-working lithographic printing plate precursor, which is excellent in chemical resistance, particularly, resistance to chemicals used at the printing, and has a good handling property in the production and high sensitivity, and a method for the preparation thereof.

Other objects of the invention will become apparent from the following description.

As a result of the extensive investigations, the inventor has found that the use of a solvent having a specific physical property facilitates the production of coating solution for a photosensitive layer in which a binder excellent in chemical resistance is employed to complete a lithographic printing plate precursor for direct plate-making in which the amount of remaining solvent is controllable and which has high sensitivity. Specifically, the invention includes the following items.

1. A lithographic printing plate precursor comprising a hydrophilic support having provided thereon a first layer comprising a first resin that is water-insoluble and alkali-soluble and a second layer comprising a second resin that is water-insoluble and alkali-soluble in this order and a light-heat converting agent incorporated into at least one layer of the first layer and second layer, which further comprises at least one organic solvent selected from organic solvents having a boiling point not less than 150° C. and a dipole moment not less than 3.50 debye in an amount of from 0.5 to 5% by weight based on the total dry weight of the first layer and second layer.

2. A method for the preparation of a lithographic printing plate precursor comprising applying a first layer comprising a first resin that is water-insoluble and alkali-soluble with a coating solvent containing at least one organic solvent selected from organic solvents having a boiling point not less than 150° C. and a dipole moment not less than 3.50 debye and then applying a second layer comprising a second resin that is water-insoluble and alkali-soluble with a solvent having a boiling point less than 150° C. that does not contain the organic solvent having a boiling point not less than 150° C. and a dipole moment not less than 3.50 debye used for the application of the first layer.

### BRIEF DESCRIPTION OF THE DRAWING

FIG. 1 is a schematic diagram showing one embodiment of a continuous coating and drying apparatus for use in the preparation of the lithographic printing plate precursor of the invention.

1: First layer coated product

2: Coating head

3: First drying zone

4: Second drying zone

5: Inlet (first drying zone)

6: Outlet (first drying zone)

7: Inlet (second drying zone)

8: Outlet (second drying zone)

9: High-pressure air generating device

10: Heat exchanger

11: Pressure indicator

12: High-pressure air blowing nozzle

13, 14, 15, 16, 17: Guide roll

18, 19: Airflow control damper

### DETAILED DESCRIPTION OF THE INVENTION

According to the invention, an organic solvent selected from organic solvents, which is a liquid state at a temperature of 25° C. and has a boiling point not less than 150° C. and a dipole moment not less than 3.50 debye is employed. In general, a solvent having a relatively not so large polarity, for example, a petroleum hydrocarbon solvent or an alcoholic solvent is used in printing ink, chemicals used at the printing or the like. Therefore, in order to provide resistance to such a solvent, it is necessary to select an alkali-soluble resin having a high polarity and a low solubility in such a solvent. Such a resin has a low solubility in a solvent conventionally used for coating a photosensitive layer. On the contrary, the use of a solvent having a dipole moment not less than 3.50 debye (D), that is, a solvent having a high polarity, as described in the invention makes it possible to prepare a coating solution in a short period of time. Thus, the preparation of a coating solution can be performed with a good handling property at the production.

According to the invention, it is necessary that an amount of the solvent having a boiling point not less than 150° C. and a dipole moment not less than 3.50 debye present in the layer is controlled to a range of from 0.5 to 5% by weight. It is difficult to univocally express a specific method for controlling the amount of the solvent because the method for control may be varied depending on various factors, for example, a kind of solvent a kind of alkali-soluble resin or a dry weight of photosensitive composition.

Therefore, with each photosensitive composition an airflow amount for drying, a drying temperature and a drying time for the first layer, a cooling time and temperature until coating of the second layer, and an airflow amount for drying, a drying temperature and a drying time for the second layer are set so as to control a remaining amount of the solvent having a boiling point not less than 150° C. and a dipole moment not less than 3.50 debye to a range of from 0.5 to 5% by weight.

Also, such a solvent having a high polarity has a function for inhibiting a hydrogen bond-forming interaction between binders in the photosensitive layer and exhibits an effect on improving developability of the photosensitive layer to an alkali developer so that the solvent can greatly contribute to restrain of residual color and increase in sensitivity. Furthermore, by using such a solvent having a boiling point not less than 150° C., it makes possible to prepare a lithographic printing plate precursor in which volatilization of the solvent present therein is prevented during preservation of the lithographic printing plate precursor and which has good preservation stability.

The invention will be described in more detail below.

The lithographic printing plate precursor of the invention is characterized by comprising a hydrophilic support having provided thereon a first layer (lower layer) comprising a first resin that is water-insoluble and alkali-soluble and a second layer (upper layer) comprising a second resin that is water-insoluble and alkali-soluble in this order and a light-heat converting agent incorporated into at least one layer of the first layer and second layer, and further comprising at least one organic solvent selected from organic solvents having a boiling point not less than 150° C. and a dipole moment not less than 3.50 debye in an amount of from 0.5 to 5% by weight based on the total dry weight of the first layer and second layer. The first layer and the second layer are sometimes hereinafter independently or collectively referred to as a “photosensitive layer”.

<Organic Solvent Having Boiling Point not less than 150° C. and Dipole Moment not less than 3.50 Debye>

The specific solvent for use in the invention is an organic solvent having a boiling point not less than 150° C. and a dipole moment not less than 3.50 debye. Any of the organic solvents that are capable of dissolving the constituting components constituting each layer and do not chemically react with the constituting components at an ambient temperature may be used. The organic solvent is preferably liquid at an ambient temperature. (25° C.). More preferably, the organic solvent has a boiling point not more than 300° C. With respect to the species of the organic solvent, preferred examples thereof include ester solvents, nitrogen-containing solvents and sulfur-containing solvents, and more preferably nitrogen-containing solvents and sulfur-containing solvents.

Specific examples of the organic solvent having a boiling point not less than 150° C. and a dipole moment not less than 3.50 debye among these species of solvents are set forth below, but the invention should not be construed as being limited thereto. The boiling point and dipole moment of each of the organic solvents are described in parentheses, respectively.

γ-Butyrolactone (204° C., 4.12 debye), acetamide (222° C., 3.72 debye), 1,3-dimethyl-2-imidazolidinone (225.5° C., 4.05-4.09 debye), N,N-dimethylformamide (153° C., 3.86 debye), tetramethylurea (175-177° C., 3.92 debye), nitrobenzene (211.30° C., 4.21 debye), formamide (210.5° C., 3.85 debye), N-methylpyrrolidone (202° C., 4.09 debye), N,N-dimethylacetamide (166° C., 3.72 debye) and dimethylsulfoxide (1.89° C., 4.3 debye).

The organic solvents may be used individually or as a mixture of two or more thereof. As long as one organic solvent having a boiling point not less than 150° C. and a dipole moment not less than 3.50 debye is used, a solvent having a boiling point less than 150° C. or a dipole moment less than 3.50 debye may be used together therewith. Specific examples of the solvent used together are set forth below, but the invention should not be construed as being limited thereto.

Alcohols, for example, methanol, ethanol, n-propanol, isopropanol, n-butanol, isobutanol, 2-methyl-2-butanol, 2-ethyl-2-butanol, 2,4-dimethyl-3-pentanol, n-hexanol, cyclohexanol or 1-octanol; ethers, for example, dioxolane, methyl dioxolane, 3-methoxy-3-methylbutanol, 1-methoxy-2-propanol, dipropylene glycol monomethyl ether, tripropylene glycol monomethyl ether, propylene glycol monobutyl ether, propylene glycol monomethyl acetate, methyl carbitol or ethyl carbitol; ketones, for example, acetone, methyl ethyl ketone, methyl propyl ketone, methyl isobutyl ketone, methyl amyl ketone, diethyl ketone, 3-hydroxy-2-butanone, 4-hydroxy-2-butanone, cyclopentanone, cyclohexanone or diacetone alcohol; esters, for example, methyl lactate, ethyl lactate, butyl lactate, ethyl acetate, n-propyl acetate, isopropyl acetate, n-butyl acetate, methyl butyrate, ethyl butyrate or butyl butyrate; hydrocarbons, for example, n-hexane, cyclohexane, n-heptane, n-octane, toluene or xylene; and others, for example, water or dimethyl diglycol.

Such a solvent to be used is selected in consideration of solubility or dispersibility of the components used in each layer. A mixing ratio of the solvents is not particularly restricted, however, the content of the organic solvent having a boiling point not less than 150° C. and a dipole moment not less than 3.50 debye is preferably from 1 to 100% by weight, more preferably from 1 to 70% by weight, and still more preferably from 1 to 30% by weight based on the total amount of the solvents.

<Alkali-soluble Resin>

The resin that is water-insoluble and alkali-soluble (hereinafter also referred to as an “alkali-soluble resin” sometimes) for use in the first layer and second layer includes a homopolymer or copolymer containing an acidic group in the main chain and/or side chain thereof, and a mixture thereof. In order to introduce the acidic group into the polymer, any method including a method of introducing by polymerization of a monomer preliminarily having the acidic group, a method of introducing by a polymer reaction after polymerization and a method of using these methods in combination may be employed.

The alkali-soluble resins for use in the invention include various alkali-soluble polymer compounds, for example, phenol resins described, for example, in Phenol Jushi (Phenol Resins), Plastic Age Co., Ltd., Phenol Jushi no Gousei, Kouka, Kyoujinka oyobi Oyo (Synthesis, Curing, Toughening and Application of Phenol Resins), Industrial Publishing & Consulting, Inc., Plastic Zairyo Kouza (15) Phenol Jushi (Plastic Material Course (15) Phenol Resins), The Nikkan Kogyo Shimbun, Ltd. or Plastic Zensho (15) Phenol Jushi (Plastic Treatise (15) Phenol Resins), Kogyo Chosakai Publishing Co., Ltd., polyhydroxystyrenes, polyhalogenated hydroxystyrenes, copolymers of N-(4-hydroxyphenyl)methacrylamides, hydroquinone monomethacrylate copolymers, sulfonylimide polymers described in JP-A-7-28244, carboxy group-containing polymers described in JP-A-7-36184, acrylic resins containing phenolic hydroxy groups described in JP-A-51-34711, acrylic resins containing sulfonamido groups described in JP-A-2-866, urethane resins, and alkali-soluble urethane resins described in JP-A-11-153856 and JP-A-2000-112119.

The polymer favorably used in the first layer according to the invention is not particularly restricted, but polymers having acidic groups (1) to (6) described below in the main chain and/or side chain thereof are preferred in view of the solubility in an alkaline developer and the chemical resistance.

(1) a phenol group (—Ar—OH)

(2) a sulfonamido group (—SO₂NH—R).

(3) an acid group of a substituted sulfonamido type (hereinafter also referred to as an “active imido group”) (—SO₂NHCOR, —SO₂NHSO₂R or —CONHSO₂R)

(4) a carboxylic acid group (—CO₂H)

(5) a sulfonic acid group (—SO₃H)

(6) a phosphoric acid group (—OPO₃H₂)

In the acidic groups (1) to (6) described above, Ar represents a divalent aryl connecting group, which may have a substituent, and R represents a hydrocarbon group, which may have a substituent.

Of the alkali-soluble resins having the acidic group selected from (1) to (6) described above, alkali-soluble resins having (1) a phenol group, (2) a sulfonamido group, (3) an active imido group or (4) a carboxylic acid group are preferred and particularly, alkali-soluble resins having (1) a phenol group, (2) a sulfonamido group or (4) a carboxylic acid group are most preferred from the standpoint of sufficiently obtaining the solubility in an alkaline developer, development latitude and film strength.

Examples of the alkali-soluble resin having the acidic group selected from (1) to (6) described above include the following resins.

(1) Examples of the alkali-soluble resin having a phenol group include novolak resins, resole resins, polyvinyl phenol resins and acrylic resins having phenolic hydroxy groups. Of the resins, novolak resins, resole resins and polyvinyl phenol resins are preferred in view of the image-forming property and thermosetting property, novolak resins and polyvinyl phenol resins are more preferred in view of the stability, and novolak resins are particularly preferred in view of the ease of availability of raw material and versatility.

The term “novolak resin” as used herein means a resin obtained by polycondensation of at least one kind of phenols, for example, phenol, o-cresol, m-cresol, p-cresol, 2,5-xylenol, 3,5-xylenol, o-ethylphenol, m-ethylphenol, p-ethylphenol, propylphenol, n-butylphenol, tert-butylphenol, 1-naphthol, 2-naphthol, pyrocatechol, resorcinol, hydroquinone, pyrogallol, 1,2,4-benzenetriol, phloroglucinol, 4,4′-biphenyldiol or 2,2-bis(4′-hydroxyphenyl)propane with at least one kind of aldehydes, for example, formaldehyde, acetaldehyde, propionaldehyde, benzaldehyde or furfural (paraformaldehyde in place of formaldehyde or paraldehyde in place of acetaldehyde may be used) and ketones, for example, acetone, methyl ethyl ketone or methyl isobutyl ketone, in the presence of an acidic catalyst.

In the invention, polycondensation products of phenol, o-cresol, m-cresol, p-cresol, 2,5-xylenol, 3,5-xylenol, or resorcinol, as the phenol, with formaldehyde, acetaldehyde or propionaldehyde, as the aldehyde or ketone, are preferred. Particularly, polycondensation products of mixed phenols of m-cresol:p-cresol:2,5-xylenol:3,5-xylenol:resorcinol in a molar ratio of 40 to 100:0 to 50:0 to 20:0 to 20:0 to 20 with formaldehyde and polycondensation products of (mixed) phenol(s) of phenol m-cresol:p-cresol in a molar ratio of 0 to 100:0 to 70:0 to 60 with formaldehyde are preferred.

It is preferred to incorporate a dissolution inhibiting agent described hereinafter into the positive-working photosensitive composition for use in each layer. In such a case, polycondensation products of mixed phenols of m-cresol:p-cresol:2,5-xylenol:3,5-xylenol:resorcinol in a molar ratio of 70 to 100:0 to 30:0 to 20:0 to 20:0 to 20 with formaldehyde and polycondensation products of mixed phenols of phenol:m-cresol:p-cresol in a molar ratio of 10 to 100:0 to 60:0 to 40 with formaldehyde are preferred.

Further, as the alkali-soluble resin having a phenol group include, polymers comprising polymerizable monomer having a phenol group are exemplified.

Examples of the polymerizable monomer having a phenol group include an acryl amide, a methacrylamide, an acrylate and a methacrylate each having a phenol group, and a hydroxystyrene.

Specifically, N-(2-hydroxyphenyl)acrylamide, N-(3-hydroxyphenyl)acrylamide, N-(4-hydroxyphenyl)-acrylamide, N-(2-hydroxyphenyl)methacrylamide, N-(3-hydroxyphenyl)methacrylamide, N-(4-hydroxyphenyl)methacrylamide, o-hydroxyphenyl acrylate, m-hydroxyphenyl acrylate, p-hydroxyphenyl acrylate, o-hydroxyphenyl methacrylate, m-hydroxyphenyl methacrylate, p-hydroxyphenyl methacrylate, o-hydroxystyrene, m-hydroxystyrene, p-hydroxystyrene, 2-(2-hydroxyphenyl)ethyl acrylate, 2-(3-hydroxyphenyl)ethyl acrylate, 2-(4-hydroxyphenyl)ethyl acrylate, 2-(2-hydroxyphenyl)ethyl methacrylate, 2-(3-hydroxyphenyl)ethyl methacrylate and 2-(4-hydroxyphenyl)ethyl methacrylate are preferably used.

Moreover, a method in which an acid group precursor is polymerized to prepare a polymer and then the acid precursor of the polymer is converted to an acid group may be used. Foe instance, p-acetoxystyrene is polymerized as the acid group precursor and then the ester portion is hydrolyzed to convert to a phenolic hydroxy group.

In addition, a polycondensation product of a phenol containing as a substituent an alkyl group having from 3 to 8 carbon atoms with formaldehyde, for example, tert-butylphenol formaldehyde resin or octylphenol formaldehyde resin described in U.S. Pat. No. 4,123,279 is preferably exemplified.

(2) Examples of the alkali-soluble resin having a sulfonamido group include a polymer containing as the main constituting component a minimum constituting unit derived from a compound having a sulfonamido group. Examples of the compound having a sulfonamido group include a compound having at least one sulfonamido group wherein at least one hydrogen atom is bonded to the nitrogen atom and at least one polymerizable unsaturated group in the molecule thereof. Among them, low-molecular compounds having both an acryloyl group, an allyl group or a vinyloxy group and a substituted or unsubstituted aminosulfonyl group or a substituted sulfonylimino group in the molecules thereof are preferred. Examples of such low-molecular compounds include compounds represented by the following formulae (i) to (v)

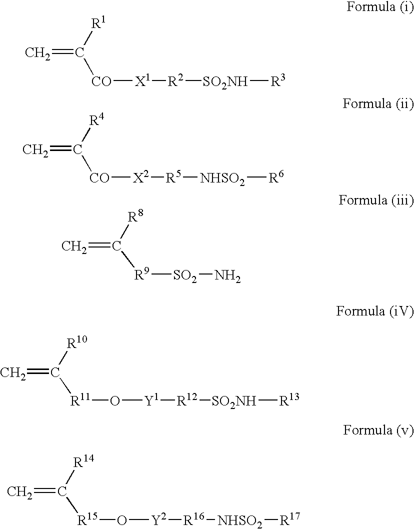

In formulae (i) to (v), X¹ and X² each independently represent —O— or —NR⁷—. R¹ and R⁴ each independently represent a hydrogen atom or —CH₃. R², R⁵, R⁹, R¹² and R¹⁶ each independently represent an alkylene group having from 1 to 12 carbon atoms, a cycloalkylene group, an arylene group or an aralkylene group, each of which may have a substituent. R³, R⁷ and R¹³ each independently represent a hydrogen atom or an alkyl group having from 1 to 12 carbon atoms, a cycloalkyl group, an aryl group or an aralkyl group, each of which may have a substituent. R⁶ and R¹⁷ each independently represent an alkyl group having from 1 to 12 carbon atoms, a cycloalkyl group, an aryl group or an aralkyl group, each of which may have a substituent. R⁸, R¹⁰ and R¹⁴ each independently represent a hydrogen atom or CH₃. R¹¹ and R¹⁵ each independently represent a single bond or an alkylene group having from 1 to 12 carbon atoms, a cycloalkylene group, an arylene group or an aralkylene group, each of which may have a substituent Y¹ and Y² each independently represent a single bond or CO.

Of the compounds represented by formulae (i) to (v), for example, m-aminosulfonylphenyl methacrylate, N-(p-aminosulfonylphenyl)methacrylamide and N-(p-aminosulfonylphenyl)acrylamide are particularly preferably used in the positive-working lithographic printing plate precursor of the invention.

(3) Examples of the alkali-soluble resin having an active imido group include a polymer containing as the main constituting component a minimum constituting unit derived from a compound having an active imido group. Examples of the compound having an active imido group include a compound having at least one active imido group represented by the structure shown below and at least one polymerizable unsaturated group in the molecule thereof.

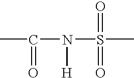

Specifically, for example, N-(p-toluenesulfonyl)methacrylamide and N-(p-toluenesulfonyl)acrylamide are preferably used.

(4) Examples of the alkali-soluble resin having a carboxylic acid group include a polymer containing as the main constituting component a minimum constituting unit derived from a compound having at least one carboxylic acid group and at least one polymerizable unsaturated group in the molecule thereof.

(5) Examples of the alkali-soluble resin having a sulfonic acid group include a polymer containing as the main constituting component a minimum constituting unit derived from a compound having at least one sulfonic acid group and at least one polymerizable unsaturated group in the molecule thereof.

(6) Examples of the alkali-soluble resin having a phosphoric acid group include a polymer containing as the main constituting component a minimum constituting unit derived from a compound having at least one phosphoric acid group and at least one polymerizable unsaturated group in the molecule thereof.

Favorable examples of the alkali-soluble resin included in the second layer according to the invention are not particularly restricted but resins containing phenolic hydroxy groups are preferred in view of the solubility and expression of dissolution inhibiting function. As the alkali-soluble resins containing phenolic hydroxy groups, the alkali-soluble resins included in the first layer described above can be employed.

It is not necessary to use only one kind of the minimum constituting units having the acidic group selected from those described above, which constitutes the alkali-soluble resin, and a copolymer obtained by copolymerization of two or more minimum constituting units having the same acidic group or a copolymer obtained by copolymerization of two or more minimum constituting units having different acidic groups may be used.

In the copolymer described above, a content of the compound having the acidic group selected from those described above for copolymerization is preferably not less than 10 mol %, and more preferably not less than 20 mol % in the copolymer. In the case where the content of the monomer is less than 10 mol %, the solubility in alkali becomes poor and the effect of improving development latitude is sometimes not sufficiently achieved.

When the alkali-soluble resin for use in the invention is a copolymer obtained by copolymerization of compounds, a compound not having the acidic group selected from (1) to (6) described above may be used as a compound copolymerized with the compound having the acidic group. Examples of the compound not having the acidic group include compounds illustrated in (m1) to (m13) below, but the compound should not be construed as being limited thereto.

(m1) acrylates and methacrylates each having an aliphatic hydroxy group, for example, 2-hydroxyethyl acrylate or 2-hydroxyethylmethacrylate;

(m2) alkyl acrylates, for example, methyl acrylate, ethyl acrylate, propyl acrylate, butyl acrylate, amyl acrylate, hexyl acrylate, octyl acrylate, benzyl acrylate, 2-chloroethyl acrylate or glycidyl acrylate;

(m3) alkyl methacrylates, for example, methyl methacrylate, ethyl methacrylate, propyl methacrylate, butyl methacrylate, amyl methacrylate, hexyl methacrylate, cyclohexyl methacrylate, benzyl methacrylate, 2-chloroethyl methacrylate or glycidyl methacrylate;

(m4) acrylamides or methacrylamides, for example, acrylamide, methacrylamide, N-methylolacrylamide, N-ethylacrylamide, N-hexylmethacrylamide, N-cyclohexylacrylamide, N-hydroxyethylacrylamide, N-phenylacrylamide, N-nitrophenylacrylamide or N-ethyl-N-phenylacrylamide;

(m5) vinyl ethers, for example, ethyl vinyl ether, 2-chloroethyl vinyl ether, hydroxyethyl vinyl ether, propyl vinyl ether, butyl vinyl ether, octyl vinyl ether or phenyl vinyl ether;

(m6) vinyl esters, for example, vinyl acetate, vinyl chloroacetate, vinyl butyrate or vinyl benzoate;

(m7) styrenes, for example, styrene, α-methylstyrene, methylstyrene, chloromethylstyrene or p-acetoxystyrene;

(m8) vinyl ketones, for example, methyl vinyl ketone, ethyl vinyl ketone, propyl vinyl ketone or phenyl vinyl ketone;

(m9) olefins, for example, ethylene, propylene, isobutylene, butadiene or isoprene;

(m10) N-vinylpyrrolidone, acrylonitrile or methacrylonitrile;

(m11) unsaturated imides, for example, maleimide, N-acryloylacrylamide, N-acetylmethacrylamide, N-propionylmethacrylamide or N-(p-chlorobenzoyl)methacrylamide;

(m12) maleic anhydride, itaconic anhydride, acrylic chloride or methacrylic chloride; and

(m13) methacrylic acid monomer having a hetero atom bonded to the α-position, for example, compounds described in JP-A-2002-309057 and JP-A-2002-311569.

In the invention, when the alkali-soluble resin is a homopolymer or copolymer formed from (1) polymerizable monomer having a phenolic hydroxy group, (2) polymerizable monomer having a sulfonamido group, (3) polymerizable monomer having an active imido group, (4) polymerizable monomer having a carboxylic acid group, (5) polymerizable monomer having a sulfonic acid group or (6) polymerizable monomer having a phosphoric acid group, the polymer has preferably a weight average molecular weight (which is measured by gel permeation chromatography and calculated in terms of styrene) of not less than 2,000 and a number average molecular weight of not less than 500, and more preferably a weight average molecular weight of from 5,000 to 300,000, a number average molecular weight of from 800 to 250,000 and a dispersion degree (weight average molecular weight/number average molecular weight) of from 1.1 to 10.

In the invention, when the alkali-soluble resin is a novolak resin, the novolak resin preferably has a weight average molecular weight of from 500 to 100,000 and a number average molecular weight of from 200 to 50,000. Novolak resins having a small content of low molecular weight component described in JP-A-2002-323755 may also be used.

The alkali-soluble resins may be used individually or in combination of two or more thereof. The amount of the alkali-soluble resin added is ordinarily from 30 to 99% by weight, preferably from 40 to 95% by weight, and particularly preferably from 50 to 90% by weight based on the total solid content of each layer.

When the amount of the alkali-soluble resin added is not less than 30% by weight, durability of the photosensitive layer is favorable and on the other hand, the amount of the alkali-soluble resin added not more than 99% by weight is preferable in view of the sensitivity and image-forming property.

The copolymers included in the first layer may be used individually or in combination of two or more thereof. The amount of the copolymer added is ordinarily not less than 50% by weight, and preferably not less than 55% by weight based on the total solid content of the first layer. By using the copolymer in the amount of not less than 50% by weight, favorable printing durability of the lithographic printing plate precursor can be obtained.

To the composition for the first later, various additives can be added in addition to the copolymer described above, if desired. For instance, it is preferred to use a substance, which is thermally decomposable and can substantially decrease the solubility of the alkali-soluble polymer compound before being thermally decomposed, for example, an onium salt, an o-quinonediazide compound, an aromatic sulfone compound or an aromatic sulfonic acid ester compound for the purpose of improving the dissolution inhibiting property of the image area in a developer. Examples of the onium salt include a diazonium salt, an ammonium salt, a phosphonium salt, an iodonium salt, a sulfonium salt, a selenonium salt and an arsonium salt. In the invention, the diazonium salt is particularly preferred. As the particularly preferred diazonium salts, those described in JP-A-5-158230 are exemplified.

Preferred examples of the quinonediazide include o-quinonediazide compounds. The oquinonediazide compound for use in the invention is a compound having at least one o-quinonediazido group, which increases the alkali solubility upon thermal decomposition, and compounds having various structures can be used. In other words, o-quinonediazide assists dissolution of the photosensitive system by its two effects, that is, the o-quinonediazide loses the dissolution inhibiting ability to the binder upon thermal decomposition and the o-quinonediazide itself changes into an alkali-soluble substance. Examples of the o-quinonediazide compound, which can be used in the invention, include compounds described in J. Kosar, Light-Sensitive Systems, pages 339 to 352, John Wiley & Sons, Inc. In particular, sulfonic acid esters or sulfonic acid amides of o-quinonediazide, obtained by reacting with various aromatic polyhydroxy compounds or aromatic amino compounds, are preferred. Also, ester of benzoquinone-(1,2)-diazidosulfonic chloride or naphthoquinone-(1,2)-diazido-5-sulfonic chloride with a pyrogallol-acetone resin described in JP-B-43-28403, and ester of benzoquinone-(1,2)-diazidosulfonic chloride or naphthoquinone-(1,2)-diazido-5-sulfonic chloride with a phenol-formaldehyde resin described in U.S. Pat. Nos. 3,046,120 and 3,188,210 are preferably used.

Furthermore, an ester of naphthoquinone-(1,2)-diazido-4-sulfonic chloride with a phenol-formaldehyde resin or cresol-formaldehyde resin, and an ester of naphthoquinone-(1,2)-diazido-4-sulfonic chloride with a pyrogallol-acetone resin are also preferably used.

The amount of the o-quinonediazide compound added is preferably from 1 to 50% by weight, more preferably from 5 to 30% by weight, and particularly preferably from 10 to 30% by weight based on the total solid content of the constituting composition of the first layer for forming the lithographic printing plate precursor. The o-quinonediazide compounds may be used individually or as a mixture of a plurality of the compounds.

Examples of the counter ion of the onium salt include anions of tetrafluoroboric acid, hexafluorophosphoric acid, triisopropylnaphthalenesulfonic acid, 5-nitro-o-toluenesulfonic acid, 5-sulfosalicylic acid, 2,5-dimethylbenzenesulfonic acid, 2,4,6-trimethylbenzenesulfonic acid, 2-nitrobenzenesulfonic acid, 3-chlorobenzenesulfonic acid, 3-bromobenzenesulfonic acid, 2-fluorocaprylnaphthalenesulfonic acid, dodecylbenzenesulfonic acid, 1-naphthol-5-sulfonic acid, 2-methoxy-4-hydroxy-5-benzoylbenzenesulfonic acid and para-toluenesulfonic acid. Among, the compounds, hexafluorophosphoric acid and an alkylaromatic sulfonic acid, for examples triisopropylnaphthalenesulfonic acid or 2,5-dimethylbenzenesulfonic acid are preferred.

The amount of the additive other than the o-quinonediazide compound is preferably from 1 to 50% by weight, more preferably from 5 to 30% by weight, and particularly preferably from 10 to 30% by weight based on the constituting composition of the first layer of the lithographic printing plate precursor.

For the purpose of further increasing the sensitivity, a cyclic acid anhydride, a phenol or an organic acid may be used together. Examples of the cyclic acid anhydride, which can be used, include phthalic anhydride, tetrahydrophthalic anhydride, hexahydrophthalic anhydride, 3,6-endoxy-Δ4-tetrahydrophthalic anhydride, tetrachlorophthalic anhydride, maleic anhydride, chloromaleic anhydride, α-phenylmaleic anhydride, succinic anhydride and pyromellitic anhydride described in U.S. Pat. No. 4,115,128. Examples of the phenol include bisphenol A, p-nitrophenol, p-ethoxyphenol, 2,4,4′-trihydroxybenzophenone, 2,3,4-trihydroxybenzophenone, 4-hydroxybenzophenone, 4,4′,4″-trihydroxytriphenylmethane and 4,4′,3″,4″-tetrahydroxy-3,5,3′,5′-tetramethyltriphenylmethane. Examples of the organic acid include sulfonic acids sulfinic acids, alkylsulfuric acids, phosphonic acids, phosphoric acid esters and carboxylic acids described in JP-A-60-788942 and JP-A-2-96755. Specific examples thereof include p-toluenesulfonic acid, dodecylbenzenesulfonic acid, toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, phthalic acid, terephthalic acid, 4-cyclohexene-1,2-dicarboxylic acid, erucic acid, lauric acid, n-undecanoic acid and ascorbic acid. The content of the cyclic acid anhydride, phenol or organic acid is preferably from 0.05 to 20% by weight, more preferably from 0.1 to 15% by weight, and particularly preferably from 0.1 to 10% by weight based on the total solid content of the composition constituting the first layer.

According to the present invention, a fatty acid having a large number of carbon atoms or a derivative thereof, which is so-called wax, can be added to the first layer for the purpose of improving stability before development. Fatty acids or fatty acid esters including an alkyl group having from 6 to 32 carbon atoms or an alkenyl group having from 6 to 32 carbon atoms (for example, a straight chain alkyl group, e.g., n-hexyl group, n-heptyl group, n-octyl group, n-nonyl group, n-decyl group or n-undecyl group, a branched alkyl group, e.g., 14-methylpentadecyl group or 16-methylheptadecyl group, or an alkenyl group, e.g., 1-hexenyl group, 1-heptenyl group 1-octenyl group or 2-methyl-1-heptenyl group) are preferably used. Among them, those including an alkyl group having not more than 25 carbon atoms or an alkenyl group having not more than 25 carbon atoms are preferred in view of the solubility in a solvent for coating. Specific examples of the compound, which can be used, include as the fatty acid, enanthic acid, caprylic acid, pelargonic acid, capric acid, undecylic acid, lauric acid, tridecylic acid, myristic acid, pentadecylic acid, palmitic acid, heptadecylic acid, stearic acid, nonadecanoic acid, arachic acid, behenic acid, lignoceric acid, cerotic acid, heptacosanoic acid, montanic acid, melissic acid, lacseric acid, undecylic acid, oleic acid, elaidic acid, cetleinic acid, erucic acid and brassidic acid. Specific examples of the fatty acid ester include methyl esters, ethyl esters, propyl esters, butyl esters, dodecyl esters, phenyl esters or naphthyl esters of these fatty acids. Examples of thiofatty acid ester include methyl thioesters, ethyl thioesters, propyl thioesters, butyl thioesters or benzyl thioesters of these fatty acids. Examples of fatty acid amide include amides, methylamides or ethylamides of these fatty acids.

The compounds may be used individually or in combination of two or more thereof. The amount of the compound added is ordinarily from 0.02% to 10% by weight, more preferably from 0.2 to 10% by weight, and particularly preferably from 2 to 10% by weight based on the constituting composition of the first layer of the lithographic printing plate precursor. By adjusting the amount of the compound added to the above-described range, sufficient development stability can be obtained.

Further, for enhancing the stability of processing to development conditions, a nonionic surfactant described in JP-A-62-251740 and JP-A-3-208514 or an amphoteric surfactant described in JP-A-59-121044 and JP-A-4-13149 can be added to the constituting composition of the first layer. Specific examples of the nonionic surfactant include sorbitan tristearate, sorbitan monopalmitate, sorbitan trioleate, stearic acid monoglyceride and polyoxyethylene nonylphenyl ether. Specific examples of the amphoteric surfactant include alkyldi(aminoethyl)glycine, alkylpolyaminoethylglycine hydrochloride, 2-alkyl-N-carboxyethyl-N-hydroxyethylimidazolinium betaine and N-tetradecyl-N,N-betaine type (e.g., Amorgen K, trade name, manufactured by Dai-ich Kogyo Seiyaku Co., Ltd.). The content of the nonionic surfactant or amphoteric surfactant is preferably from 0.05 to 15% by weight, and more preferably from 0.1 to 5% by weight based on the constituting composition of the first layer.

To the constituting composition of the first layer according to the invention can be added a printing-out agent for obtaining a visible image immediately after heating upon light exposure, or a dye or pigment serving as an image-coloring agent. As the printing-out agent, a combination of a compound capable of releasing an acid under the heating upon light exposure (photo-acid releasing agent) and an organic dye capable of forming a salt is representatively exemplified. Specific examples thereof include combinations of o-naphthoquinonediazido-4-sulfonic acid halogenide and salt-forming organic dyes described in JP-A-50-36209 and JP-A-53-8128, and combinations of trihalomethyl compounds and salt-forming organic dyes described in JP-A-53-36223, JP-A-54-74728, JP-A-60-3626, JP-A-61-143748, JP-A-61-151644 and JP-A-63-58440. The trihalomethyl compounds include oxazole compounds and triazine compounds, and both compounds have excellent storage stability and give clear print-out images.

As the image-coloring agent, in addition to the above-described salt-forming organic dyes, other dyes can be used. Preferred dyes include oil-soluble dyes and basic dyes including the salt-forming organic dyes. Specific examples thereof include Oil Yellow #101, Oil Yellow #103, Oil Ping #312, Oil Green BG, Oil Blue BOS, Oil Blue #603, Oil Black BY, Oil Black BS, Oil Black T-505 (all manufactured by Orient Chemical Industry Co., Ltd.), Victoria Pure Blue, Crystal Violet (CI42555), Methyl Violet (CI42535), Ethyl Violet, Rhodamine B (CI45170B), Malachite Green (CI42000) and Methylene Blue (CI52015). Also, dyes described in JP-A-62-293247 are particularly preferred. The dye can be added in an amount of from 0.01 to 10% by weight, and preferably from 0.1 to 3% by weight based on the total solid content of the constituting composition for the first layer.

Moreover, to the constituting composition of the first layer, a plasticizer is added, if desired, so as to impart flexibility or the like to the coated film. Examples of the plasticizer include butyl phthalyl, polyethylene glycol, tributyl citrate, diethyl phthalate, dibutyl phthalate, dihexyl phthalate, dioctyl phthalate, tricresyl phosphate, tributyl phosphate, trioctyl phosphate, tetrahydrofurfuryl oleate, oligomers and polymers of acrylic acid or methacrylic acid. Further, a long-chain fatty acid ester, a long-chain fatty acid amide or the like may be added in order to improve film strength.

To the constituting composition of the first layer according to the invention, a surfactant for improving coating property, for example, a fluorine-containing surfactant described in JP-A-62-170950 can be added. The amount of such a surfactant is preferably from 0.01 to 1% by weight, and more preferably from 0.05 to 0.5% by weight based on the total constituting composition of the layer.

In case of using the lithographic printing plate precursor of the invention as a negative-working lithographic printing plate precursor, it is necessary to add a substance (crosslinking agent) that is capable of crosslinking the alkali-soluble resin upon an acid in order to form an alkali-insoluble film (image area). Examples of the substance that is capable of crosslinking the alkali-soluble resin upon an acid preferably used in the photosensitive layer according to the invention include (a) a compound having two or more groups selected from a hydroxymethyl group, an alkoxymthyl group, an epoxy group and a vinyl ether group, each of which is bonded to a benzene ring in its molecule, (b) a compound having an N-hydroxymethyl group, an N-alkoxymthyl group or an N-acyloxymethyl group and (c) an epoxy compound.

Specific examples of the compound (a) having two or more groups selected from a hydroxymethyl group, an alkoxymthyl group, an epoxy group and a vinyl ether group, each of which is bonded to a benzene ring in its molecule include a methylol melamine, a resole resin, an epoxylated novolak resin and a urea resin. Further, compounds described in Sinzo Yamashita and Tousuke Kanoko, Kakyozai Handbook (Handbook of Crosslinking Agents), Taiseisha Co., Ltd. are preferably used. Particularly, a phenol derivative having two or more hydroxymethyl groups or alkoxymthyl groups in its molecule is preferred because it provides favorable image strength after the image formation. Specific examples thereof include a resole resin.

However, since these crosslinking agents capable of crosslinking upon an acid are unstable to heat, a lithographic printing plate precursor prepared may exhibit poor stability during preservation. On the contrary, a phenol derivative, which has a molecular weight of not more than 1,200, and contains from 3 to 5 benzene rings that may have a substituent and two or more groups selected from a hydroxymethyl group and an alkoxymethyl group, that are connected to benzene rings in the molecule thereof, is excellent in the stability during preservation and thus it is most favorably used in the invention. The alkoxymethyl group included in the phenol derivative preferably includes an alkoxymethyl group having not more than 6 carbon atoms. Specific examples of the alkoxymethyl group include a methoxymethyl group, an ethoxymethyl group, an n-propoxymethyl group, an isopropoxymethyl group, an n-butoxymethyl group, isobutoxymethyl group, a sec-butoxymethyl group and a tert-butoxymethyl group. An alkoxy-substituted alkoxy group, for example, a 2-methoxyethoxy group or a 2-methoxy-1-propyloxy group is also preferred.

The phenol derivative having a hydroxymethyl group can be obtained by reacting a corresponding phenol compound having no hydroxymethyl group with formaldehyde in the presence of a base catalyst. In such a case, it is preferred to carry out the reaction at a temperature of not higher than 60° C. in order to prevent the occurrence of resinification or gelation. Specifically, the phenol derivative can be synthesized according to methods described, for example, in JP-A-6-282067 and JP-A-7-64285.

The phenol derivative having an alkoxymethyl group can be obtained by reacting a corresponding phenol derivative having a hydroxymethyl group with an alcohol in the presence of an acid catalyst. In such a case, it is preferred to carry out the reaction at a temperature of not higher than 100° C. in order to prevent the occurrence of resinification or gelation. Specifically, the phenol derivative can be synthesized according to methods described, for example, in European Patent 632,003.

Examples of the compound (b) having an N-hydroxymethyl group, an N-alkoxymethyl group or an N-acyloxymethyl group include monomers and oligomer-melamine-formaldehyde condensates and urea-formaldehyde condensates described in EP-A-133,216 and West German Patents 3,634,671 and 3,711,264, and alkoxy-substituted compounds described in EP-A-212,482. More referred examples thereof include a melamine-formaldehyde derivative having at least two groups selected from a free N-hydroxymethyl group, an N-alkoxymethyl group and an N-acyloxymethyl group. Among them, the melamine-formaldehyde derivative having N-alkoxymethyl groups is particularly preferred.

Examples of the epoxy compound (c) include epoxy compounds containing at least one epoxy group including monomers, dimers, oligomers and polymers. Specific examples of the epoxy compound include a reaction product of bisphenol A with epichlorohydrin and a reaction product of a low molecular weight phenol-formaldehyde resin with epichlorohydrin. Epoxy resins described in U.S. Pat. No. 4,026,705 and British Patent 1,539,192 may also be used.

The amount of the crosslinking agent capable of crosslinking upon an acid used in the invention is ordinarily from 5 to 70% by weight, and preferably from 10 to 65% by weight base on the total solid content of the first layer. When the amount of the crosslinking agent capable of crosslinking upon an acid added is less than 5% by weight, film strength of the image area after the image formation is deteriorated, and on the other hand, the amount exceeding 70% by weight is disadvantageous in stability during preservation. The crosslinking agents capable of crosslinking upon an acid may be used individually or in combination of two or more thereof.

The coating amount of the composition constituting the first layer provided on a support of the lithographic printing plate precursor is preferably in a range of from 0.5 to 4.0 g/m². When the coating amount is less than 0.5 g/m², effect for improving the printing durability becomes insufficient. When the coating amount exceeds 4.0 g/m², remaining color or residual film due to inferior development is apt to occur. Thus, such cases are not preferred.

According to the lithographic printing plate precursor of the invention, the first layer comprising the above-described specific copolymer is provided on a support and on the first layer, as the second layer comprising the second resin that is water-insoluble and alkali-soluble, a layer containing a resin being soluble in an aqueous alkali solution and having a phenolic hydroxy group in an amount of no less than 50% by weight is provided.

<Light-heat Converting Agent>

A compound capable of absorbing light to generate heat, that is, a light-heat converting agent is incorporated into the first layer, the second layer or the both of these layers in the invention. Particularly, it is preferred that the light-heat converting agent is incorporated into the second layer (upper layer).

Also, into the second layer, a compound capable of absorbing light to generate heat is incorporated together with a resin having a phenolic hydroxy group. The compound capable of absorbing light to generate heat means a compound having a light absorption range in an infrared region of not shorter than 700 nm, preferably from 750 to 1,200 nm and expressing a light/heat converting function in such a wavelength range. Specifically, various kinds of pigments and dyes absorbing light in such a wavelength range and generating heat can be used.

As the pigment, commercially available pigments and pigments described in Colour Index (C.I.), Saishin Ganryo Binran (Latest Pigment Handbook), edited by Nippon Ganryo Gijutsu Kyokai (1977), Saishin Ganryo Oyo Gijutsu (Latest Pigment Application Techniques), CMC Publishing Co., Ltd. (1986) and Insatu-inki Gijutsu (Printing Ink Techniques), CMC Publishing Co., Ltd. (1984) can be utilized.

The pigments include black pigments, yellow pigments, orange pigments, brown pigments, red pigments, violet pigments, blue pigments, green pigments, fluorescent pigments, metal powder pigments and polymer-bonding dyes. Specifically, insoluble azo pigments, azo lake pigments, condensed azo pigments, chelate azo pigments, phthalocyanine pigments, anthraquinone pigments, perylene and perylone pigments, thioindigo pigments, quinacridone pigments, dioxazine pigments, isoindolinone pigments, quinophthalone pigments, dying lake pigments, azine pigments, nitroso pigments, nitro pigments, natural pigments, fluorescent pigments, inorganic pigments and carbon black can be used.

The pigment may be used with or without being subjected to a surface treatment. The surface treatment method includes a method of coating a surface of pigment with a resin or wax, a method of adhering a surfactant to a surface of pigment, a method of bonding a reactive substance (for example, a silane coupling agent, an epoxy compound or a polyisocyanate) to a surface of pigment. The surface treatment methods are described in Kinzokusekken no Seishitu to Oyo (Properties and Applications of Metal Soap), published by Saiwai Shobo Co., Ltd., Insatu-inki Gijutsu (Printing Ink Techniques), CMC Publishing Co., Ltd. (1984) and Saishin Ganryo Oyo Gijutsu (Latest Pigment Application Techniques), CMC Publishing Co., Ltd. (1986).

A particle size of the pigment is preferably in a range of from 0.01 to 1 μm, more preferably in a range of from 0.05 to 1 μm and particularly preferably in a range of from 0.1 to 1 μm. To control the particle size of the pigment to the above range is preferred in view of stability of the pigment dispersion in a coating solution for the photosensitive layer and uniformity of the photosensitive layer.

In order to disperse the pigment, known dispersion techniques used for the production of ink or toner can be employed. Examples of the dispersing machine include an ultrasonic disperser, a sand mill, an attriter, a pearl mill, a super mill, a ball mill, an impeller, a disperser, a KD mill, a colloid mill, a Dynatron, a three-rod roll mill and a pressure kneader. The dispersing machines are described in detail in Saishin Ganryo Oyo Gijutsu (Latest Pigment Application Techniques), CMC Publishing Co., Ltd. (1986).

Commercially available dyes and known dyes as described in literatures (for example, Senryo Binran (Dye Handbook), edited by Yuki Gosei Kagaku Kyokai (1970) can be utilized. Specific examples of the dye include azo dyes, metal complex azo dyes, pyrazolone azo dyes, anthraquinone dyes, phthlalocyanine dyes, carbonium dyes, quinoneimine dyes, methine dyes and cyanine dyes. Of the pigments and dyes, those absorbing an infrared ray or a near infrared ray are particularly preferably used in the invention because they are suitable for use with a laser emitting an infrared ray or a near infrared ray.

As such a pigment that absorbs infrared ray or a near infrared ray, carbon black is favorably used. As such a dye that absorbs infrared ray or a near infrared ray, cyanine dyes described in JP-A-58-125246, JP-A-59-84356, JP-A-59-202829 and JP-A-60-78787, methine dyes described in JP-A-58-173696, JP-A-58-181690 and JP-A-58-194595, naphthoquinone dyes described in JP-A-58-112793, JP-A-58-224793, JP-A-59-48187, JP-A-59-73996, JP-A-60-52940 and JP-A-60-63744, squarylium dyes described in JP-A-58-112792, and cyanine dyes described in British Patent 434,875 are exemplified.

Also, near infrared absorbing sensitizers described in U.S. Pat. No. 5,156,938 are preferably used. Further, substituted arylbenzo(thio)pyrylium salts described in U.S. Pat. No. 3,881,924, trimethinethiapyrylium salts described in JP-A-57-142645 (U.S. Pat. No. 4,327,169), pyrylium compounds described in JP-A-58-181051, JP-A-58-220143, JP-A-59-41363, JP-A-59-84248, JP-A-59-84249, JP-A-59-146063 and JP-A-59-146061, cyanine dyes described in JP-A-59-216146, pentamethinethiopyrylium salts described in U.S. Pat. No. 4,283,475, pyrylium compounds described in JP-B-5-13514 and JP-B-5-19702, and commercially available products, for example, Epolight III-178, Epolight III-130 or Epolight III-125 (manufactured by Epolin Inc.) are particularly preferably used.

Other examples of the particularly preferable dye include near infrared absorbing dyes represented by formulae (I) and (II) in U.S. Pat. No. 4,765,993.

The pigment or dye may be incorporated in an amount of from 0.01 to 50% by weight, preferably from 0.1 to 10% by weight, and particularly preferably from 0.5 to 10% by weight in case of the dye or from 3.1 to 10% by weight in case of the pigment, based on the total solid content of the constituting composition of the photosensitive layer. When the amount of the pigment or dye is not less than 0.01% by weight, sufficient sensitivity is obtained. When the amount is not more than 50% by weight, uniformity of the photosensitive layer is favorable and durability of the photosensitive layer is also excellent. The dye or pigment is preferably added to the second layer but it may also be added to other layer, for example, the first layer described above.

In the invention, as the compound capable of absorbing light to generate heat incorporated into the second layer, a compound, which is compatible with a resin having a phenolic hydroxy group that is a constituting material of the second layer and decreases solubility of the resin in aqueous alkali and in which the function of decreasing the solubility of the resin is lowered upon heating, may be added. Examples of such compound include compounds represented by the following formula (I):

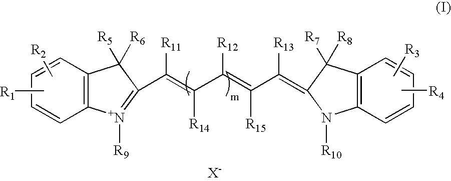

The compound has a property of absorbing light to generate heat, a light absorption range in an infrared region of from 700 to 1,200 nm and good compatibility with a resin soluble in an aqueous alkali solution, which is a basic dye, and which can be interacted with a resin soluble in an aqueous alkali solution to control the solubility of the resin in an aqueous alkali solution since it has a group capable of interacting with the resin soluble in an aqueous alkali solution, for example, an ammonium group or an iminium group in its molecule. Thus, the compound is preferably used in the invention.

In formula (I), R₁ to R₄ each independently represent a hydrogen atom, an alkyl group having from 1 to 12 carbon atoms, which may have a substituent, an alkenyl group, which may have a substituent, an alkoxy group, which may have a substituent, a cycloalkyl group, which may have a substituent, or an aryl group, which may have a substituent, or R₁ and R₂ or R₃ and R₄ may be connected with each other to form a ring structure. Specifically, R₁ to R₄ each represent, for example, a hydrogen atom, a methyl group, an ethyl group, a phenyl group, a dodecyl group, a naphthyl group, a vinyl group, an allyl group or a cyclohexyl group. When the above-described group has a substituent, examples of the substituent include a halogen atom, a carbonyl group, a nitro group, a nitryl group, a sulfonyl group, a carboxy group, a carboxylic acid ester group and a sulfonic acid eater group. R₅ to R₁₀ each independently represent an alkyl group having from 1 to 12 carbon atoms, which may have a substituent. Specifically, R₅ to R₁₀ each represent, for example, a methyl group, an ethyl group, a phenyl group, a dodecyl group, a naphthyl group, a vinyl group, an allyl group or a cyclohexyl group. When the above-described group has a substituent, examples of the substituent include a halogen atom, a carbonyl group, a nitro group, a nitryl group, a sulfonyl group, a carboxy group, a carboxylic acid ester group and a sulfonic acid eater group.

R₁₁ to R₁₃ each independently represent a hydrogen atom, a halogen atom or an alkyl group having from 1 to 8 carbon atoms, which may have a substituent, or R₁₂ and R₁₁ or R₁₂ and R₁₃ may be connected with each other to form a ring structure. When m is larger than 2, plural R₁₂s may be connected with each other to form a ring structure. Specifically, R₁₁ to R₁₃ each represent a chlorine atom or a cyclohexyl group. Examples of the ring structure formed by connecting R₁₂s each other include a cyclopentyl ring and a cyclohexyl ring. When the above-described group has a substituent, examples of the substituent include a halogen atom, a carbonyl group, a nitro group, a nitryl group, a sulfonyl group, a carboxy group, a carboxylic acid ester group and a sulfonic acid eater group m represents an integer of from 1 to 8, and preferably from 1 to 3. R₁₄ to R₁₅ each independently represent a hydrogen atom, a halogen atom or an alkyl group having from 1 to 8 carbon atoms, which may have a substituent, or R₁₄ and R₁₅ may be connected with each other to form a ring structure. When m is larger than 2, plural R₁₄s may be connected with each other to form a ring structure. Specifically, R₁₄ to R₁₅ each represent a chlorine atom or a cyclohexyl group. Examples of the ring structure formed by connecting R₁₄s each other include a cyclopentyl ring and a cyclohexyl ring. When the above-described group has a substituent, examples of the substituent include a halogen atom, a carbonyl group, a nitro group, a nitryl group, a sulfonyl group, a carboxy group, a carboxylic acid ester group and a sulfonic acid eater group m represents an integer of from 1 to 8, and preferably from 1 to 3.

In formula (I), X⁻ represents an anion. Specific examples of the anion represented by X⁻ include anions of perchloric acid, tetrafluoroboric acid, hexafluorophophoric acid, triisopropylnaphthalenesulfonic acid, 5-nitro-o-toluenesulfonic acid, 5-sulfosalicylic acid, 2,5-dimethylbenzenesulfonic acid, 2,4,6-trimethylbenzenesulfonic acid, 2-nitrobenzenesulfonic acid, 3-chlorobenzenesulfonic acid, 3-bromobenzenesulfonic acid, 2-fluorocaprylnaphthalenesulfonic acid, dodecylbenzenesulfonic acid, 1-naphthol-5-sulfonic acid, 2-methoxy-4-hydroxy-5-benzoylbenzenesulfonic acid and paratoluenesulfonic acid. Among these compounds, hexafluorophosphoric acid and an alkylaromatic sulfonic acid, for example, triisopropylnaphthalenesulfonic acid or 2,5-dimethylbenzenesulfonic acid are preferred.

The compounds represented by formula (I) are compounds ordinarily called cyanine dyes. Specific examples of the compound favorably used are set forth below, but the invention should not be construed as being limited thereto.

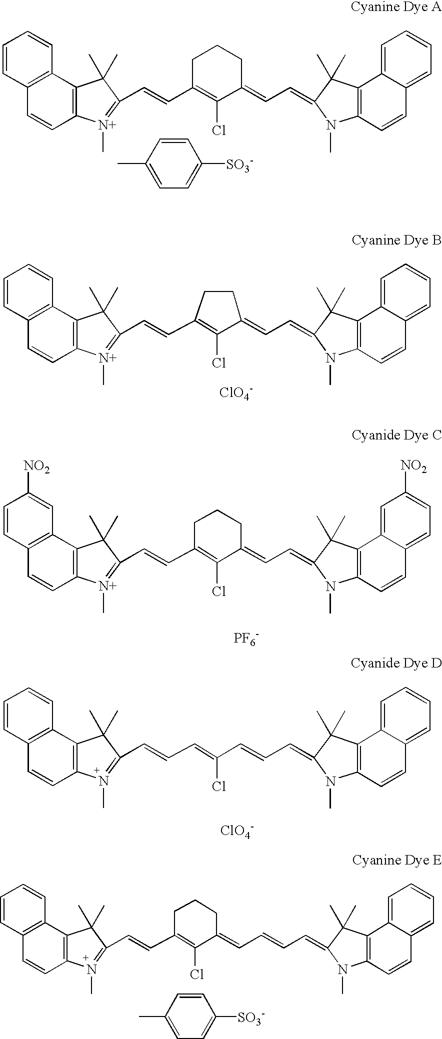

When the compound such as the cyanine dye described above is used in the invention, the amount of the compound is preferably in a range of from 1/99 to 30/70 in view of sensitivity, and more preferably in a range of from 1/99 to 25/75, in terms of weight ratio of the compound to the resin soluble in an aqueous alkali solution.

To the composition constituting the second layer according to the invention, various additives can further be added, if desired. The additives that can be used in the second layer include various additives described for adding to the composition constituting the first layer. When the lithographic printing plate precursor of the invention is used as a negative-working lithographic printing plate precursor, a crosslinking agent is also added to the second layer as well as to the first layer.

Each of these layers can be ordinarily prepared by a method of dissolving each component in a solvent and coating the solution on a support. However, when two layers are formed by coating sequentially in a conventional manner, co-solution of two layers occurs at the interface of layers due to the influence of the solvent or the like and a situation in which the first layer and the second layer are not clearly separated happens to lead to decreasing the effects of the invention. Therefore, it is necessary to form two layers separatedly from each other in the preparation of the lithographic printing plate precursor of the invention.

A method for forming isolated two layers includes, for example, a method of utilizing a difference of solvent solubility between an alkali-soluble resin used in the first layer and an alkali-soluble resin used in the second layer, and a method wherein after coating the second layer, the solvent used is rapidly dried and removed. These methods are described in detail below, but the method for forming isolated two layers should not be construed as being limited thereto.

The method of utilizing a difference of solvent solubility between an alkali-soluble resin used in the first layer and an aqueous alkali solution-soluble resin used in the second layer employs a solvent system in which both the specific alkali-soluble resin and an alkali-soluble resin used together therewith included in the first layer are insoluble at the coating of the second layer containing the aqueous alkali solution-soluble resin. Thus, when two layers are coated, each layer can be provided in a clearly separated form. For example, the formation of two layers can be conducted by a method of selecting an alkali-soluble resin including as a copolymerization component a specific monomer and constituting the component of the first layer that is insoluble in a solvent capable of dissolving the aqueous alkali solution-soluble resin used in the second layer, for example, methyl ethyl ketone or 1-methoxy-2-propanol, coating the first layer mainly containing the alkali-soluble resin using a solvent system capable of dissolving the alkali-soluble resin constituting the first layer, followed by drying, and then coating the second layer mainly containing the aqueous alkali solution-soluble resin using a solvent that does not dissolve the component of the first layer, for example, methyl ethyl-ketone or 1-methoxy-2-propanol.

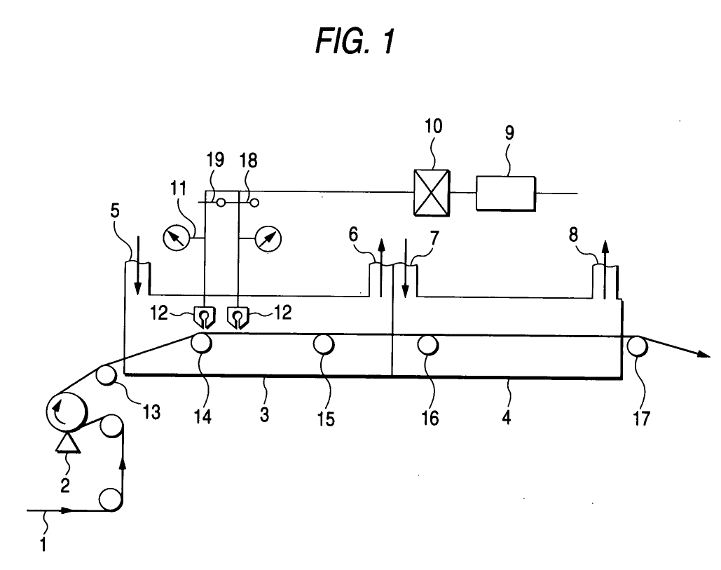

On the other hand, the method of rapidly drying a solvent after coating the second layer can be carried out by a means of spraying high-pressure air from a slit nozzle installed approximately perpendiculars to the conveying direction of a web, a means of feeding heat energy as conductive heat from the lower surface of a web by a roll (heating roll) supplied inside with a heating medium, for example, steam, or a combination of these means. One embodiment of an apparatus for conducting continuous coating and drying that is employed for the formation of the second layer after the formation of the first layer by coating and drying is shown in FIG. 1. In the apparatus of FIG. 1, the second layer is provided on the first layer coated product in which the first layer has been previously provided on a support, for example, a surface-grained aluminum web.

According to the invention, since an alkali-soluble resin provided with chemical resistance and solvent resistance and having a high polarity is used as the alkali-soluble resin in the first layer, the first layer is coated and dried using an organic solvent having a boiling point not less than 150° C. and a dipole moment not less than 3.50 debye and a solvent in which the copolymer is insoluble or hardly soluble is used for the formation of the second layer.

In the method of utilizing a difference of solvent solubility, when the alkali-soluble resin used in the first layer is completely insoluble in a coating solvent for the second layer, the multi-layer structure contemplated to the invention can be easily formed. However, there is a case where a solvent in which the alkali-soluble resin constituting the first layer is insoluble is unable to select depending on the kind of the alkali-soluble resin used in the second layer and a solvent in which the alkali-soluble resin constituting the first layer is somewhat soluble has to be selected. Further, it is also difficult to select other additive components incorporated into the first layer, which are completely insoluble in a coating solvent for the second layer.

In such a case, it is preferable to use the method of utilizing a difference of solvent solubility in combination with the method of rapidly drying to remove a solvent after coating the second layer.

In view of the above, taking the case of conducting rapidly drying after coating the second layer into consideration, it is preferred that a solvent having a boiling point less than 150° C. is used as a solvent for coating the second layer. As such a solvent, any solvent capable of dissolving or dispersing the components of the second layer can be used.

Specific examples of the solvent are set forth below, but the invention should not be construed as being limited thereto.

Alcohols, for example, methanol, ethanol, n-propanol, isopropanol, n-butanol, isobutanol, 2-methyl-2-butanol or cyclohexanol; ethers, for example, dioxolane or 1-methoxy-2-propanol; ketones, for example, acetone, methyl ethyl ketone, methyl propyl ketone, methyl isobutyl ketone, cyclopentanone, cyclohexanone or diacetone alcohol; esters, for example, ethyl acetate or isopropyl acetate; hydrocarbons, for example, n-hexane, cyclohexane, n-heptane, n-octane or toluene; and others, for example, water.

As described above, a method of applying the first layer comprising the first resin that is water-insoluble and alkali-soluble to a hydrophilic support using a coating solvent containing at least one organic solvent selected from organic solvents having a boiling point not less than 150° C. and a dipole moment not less than 3.50 debye and applying the second layer with a solvent having a boiling point less than 150° C. and not containing the organic solvent used for the application of the first layer is preferred.

The apparatus in FIG. 1 is equipped with a coating head 2 in which a coating solution for second layer is coated on the first layer coated product 1, a first drying zone 3 in which drying with hot air and a high-speed drying by blowing high-pressure air are conduced, and a second drying zone 4 in which drying with hot air is conducted. The first drying zone 3 is provided with an inlet 5 for feeding hot air, a high-pressure air generating device 9 for conducting high-speed drying, a heat exchanger 10, a pressure indicator 11, a high-pressure air blowing nozzle 12, airflow control dampers 18 and 19 and an outlet 6 for exhausting the hot air from the system. The second drying zone 4 is provided with an inlet 7 for feeding hot air and an outlet 8 for exhausting the hot air from the system. Further, guide rolls 13 to 17 for transporting an aluminum web are respectively arranged in appropriate positions of the apparatus.

In the apparatus, a coating solution for second layer is coated on the first layer coated product 1 continuously running at a rate of from 5 to 150 m/min by the coating head 2 in an amount of from 5 to 40 ml/m² and the coated product is guided into the first drying zone 3 in which drying proceeds in the first layer coated product 1 ordinarily having a temperature of from 50 to 150° C. An evaporated solvent gas is exhausted through the outlet 6 from the system together with the hot air. At the stage of drying with the hot air in the vicinity of the inlet of the first drying zone 3, the second layer coating is ordinarily still undried state.

The second layer coating in the undried state is rapidly dried with high-speed air blown to the conveying position through the high-pressure air blowing nozzle 12 arranged approximately vertically to the conveying direction of first layer coated product 1.

High-pressure air is generated by the high-pressure air generating device 9 comprising a compressor or a high-pressure blower, heated to a temperature of from 50 to 200° C. by the heat exchanger 10, adjusted to the desired air flow by the airflow control dampers 18 and 19, and fed to the high-pressure air blowing nozzle 12. Thus, slit-type high-pressure air having the desired temperature and airflow can collide vigorously against the second layer coating in the undried state to rapidly evaporate the solvent within a very short time, whereby the second layer is formed. The internal pressure of the high-pressure air blowing nozzle 12 is ordinarily from 300 mmAq (H₂O) to 3 kg/cm², and preferably from 1,000 mmAq (H₂O) to 1 kg/cm². The flow rate of blowing air from the high-pressure air blowing nozzle 12 is approximately from 20 to 300 m/sec. The slit width of the high-pressure air blowing nozzle 12 is approximately from 0.1 to 5 mm, and preferably from 0.3 to 1 mm. The blowing angle of the high-pressure air to the second layer coating is ordinarily from 0 to 90 degrees, and preferably from 10 to 60 degrees. Further, the number of the nozzles can be from 1 to about 8 depending on drying load, while it is two in the figure.

Thus, a coating film of the second layer is formed by rapid drying in the first drying zone 3. Then, the first layer coated product 1 having the second layer formed thereon is guided into the second drying zone 4 and heated with hot air having a temperature of from 100 to 150° C. from the inlet 7. Consequently, the trace amount of the residual solvent in the film is controlled in a range of from 30 to 200 mg/m². The solvent gas is exhausted through the outlet 8 from the system together with the hot air. Thus, the desired two-layered coating can be achieved by these drying operations.

Alternatively, as an example of the latter method, drying by a heating roll may be conducted in place of the drying with the high-speed air as described above in the preparation of the layers according to the invention. As an example of the apparatus used in such a case, an apparatus in which the high-pressure air generating device 9, heat exchanger 10, pressure indicator 11, high-pressure air blowing nozzle 12 and airflow control dampers 18 and 19 are not equipped and a heating roll is equipped in place of the guide roll 14 in FIG. 1 is illustrated. In such a case, a surface of the heating roll can be heated to a temperature of from 80 to 200° C. by supplying a heating medium, for example, steam inside the roll. The surface of the heating roll comes into contact with the aluminum web of the first layer coated product 1 to transfer the heat energy, thereby making it possible to conduct drying.

Further, a method of rapid removing of the solvent can be conducted by the combination of the drying with high-speed air and the drying by a heating roll. As an example of the apparatus in such a case, an apparatus of FIG. 1 in which a heating roll as described above is equipped in place of the guide roll 14 is used, whereby the solvent is more rapidly evaporated.

In the above examples such as using the apparatus of FIG. 1, the drying with hot air is first conducted in the first drying zone 3 and then the drying with hot air and the drying with high-speed air and/or heating roll are conducted. However, the first drying with hot air is eliminated and the drying with high-speed air can be conducted immediately after the coating.

In the preparation of the lithographic printing plate precursor of the invention, it is preferred to conduct continuous coating and drying using a continuous coating and drying apparatus as shown in FIG. 1 in view of efficiency and the extension of the degree of freedom of arrangement. It is also preferred that coating and drying of the first layer is conducted by an apparatus for coating and drying of the first layer similar to the apparatus for coating and drying of the second layer placed at upstream of the apparatus for coating and drying of the second layer. Further, it is preferred that surface graining of support is conducted, for example, by a surface graining means placed at upstream of a coating head of the apparatus for coating and drying of the first layer. These methods, which can perform a continuous production using a continuously conveying support, are preferably used in view of an improvement in productivity.

A ratio of coating amount of the first layer to the second layer is appropriately determined and preferably in a range of from 10:90 to 95:5, particularly preferably in a range of from 20:80 to 95:5 in terms of weight ratio.

A solution of photosensitive layer for coating on a support is prepared by dissolving the components in an appropriate solvent. The concentration of the above-described components (total solid content including additives) in the coating solution is preferably from 1 to 50% by weight. For the coating, various methods can be used and examples thereof include bar coater coating, spin coating, spray coating, curtain coating, dip coating, air knife coating, blade coating and roll coating. As the coated amount decreases, the apparent sensitivity becomes higher but the film property of the photosensitive layer is reduced.

The support for use in the invention includes a dimensionally stable plate material. Examples of the support include paper, paper laminated with plastic (for example, polyethylene, polypropylene or polystyrene), a metal plate (for example, an aluminum, zinc or copper plate), a plastic film (for example, a cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate or polyvinyl acetal film), and paper or plastic film having laminated or deposited thereon a metal described above. The support for use in the invention is preferably a polyester film or an aluminum plate. Among them, the aluminum plate is particularly preferred, since it is dimensionally stable and relatively inexpensive. The aluminum plate is preferably a pure aluminum plate or an alloy plate mainly comprising aluminum and containing a trace amount of foreign element. A plastic film having laminated or deposited thereon aluminum may also be used. Examples of the foreign element contained in the aluminum alloy include silicon, iron, manganese, copper, magnesium, chromium, zinc, bismuth, nickel and titanium. The content of foreign element in the alloy is at most 10% by weight. In the invention, particularly preferred aluminum is pure aluminum but since perfectly pure aluminum is difficult to produce in view of the refining technique, the aluminum may contain a trace amount of foreign element. The aluminum plate for use in the invention is not particularly limited on the composition and an aluminum plate conventionally known and commonly used can be appropriately used. The thickness of the aluminum plate for use in the invention is approximately from 0.1 to 0.6 mm, preferably from 0.15 to 0.4 mm, and particularly preferably from 0.2 to 0.3 mm.

Prior to surface roughening of an aluminum plate, a degreasing treatment using, for example, a surfactant, an organic solvent or an aqueous alkaline solution is performed, if desired, in order to remove rolling oil on the surface thereof. The surface roughening treatment of the aluminum plate is performed by various methods, for example, a method of mechanically roughening the surface, a method of electrochemically dissolving and roughening the surface or a method of chemically dissolving selectively the surface. In the mechanical roughening method, a known method, for example, ball graining, brush graining, blast graining or buff graining may be used. The electrochemical surface roughening method includes a method of performing the treatment by applying an alternating current or direct current through an electrolytic solution containing hydrochloric acid or nitric acid. A method using these treatments in combination described in JP-A-54-63902 may also be used. After such surface roughening, the aluminum plate is, if desired, subjected to an alkali etching treatment and a neutralization treatment and then, if desired, to an anodization treatment in order to enhance the water retentivity and abrasion resistance on the surface. The electrolyte, which can be used in the anodization treatment of the aluminum plate, includes various electrolytes capable of forming a porous oxide film, and sulfuric acid, phosphoric acid, oxalic acid, chromic acid or a mixed acid thereof is ordinarily used. The concentration of the electrolyte is appropriately determined depending on the kind of electrolyte.

The conditions of anodization treatment vary depending on the electrolyte used and therefore, cannot be indiscriminately specified, however, suitable conditions are ordinarily such that the concentration of electrolyte is from 1 to 80% by weight, the solution temperature is from 5 to 70° C., the current density is from 5to 60 A/dm², the voltage is from 1 to 100 V, and the electrolysis time is from 10 seconds to 5 minutes. When the amount of anodic oxide film is less than 1.0 g/m², insufficient printing durability may result or the non-image area of lithographic printing plate is readily scratched to cause so-called “scratch stain”, namely, adhesion of ink to the scratched part at the printing. After the anodization treatment, the aluminum surface is, if desired, subjected to a hydrophilization treatment. Examples of the hydrophilization treatment for use in the invention include a method of using an alkali metal silicate (for example, an aqueous sodium silicate solution) described in U.S. Pat. Nos. 2,714,066, 3,181,461, 3,280,734 and 3,902,734. According to the method, the support is immersed or electrolyzed in an aqueous sodium silicate solution. Further, a method of treating the support with potassium fluorozirconate described in JP-B-36-22063 or with polyvinylphosphonic acid described in U.S. Pat. Nos. 3,276,868, 4,153,461 and 4,689,272 may be used.

The lithographic printing plate precursor of the invention comprises the first layer and the second layer on the support, as the photosensitive layers but, if desired, an undercoat layer may be provided between the first layer and the support. For components of the undercoat layer, various organic compounds are used and examples thereof include carboxymethyl cellulose; dextrin; gum arabic; phosphonic acids having an amino group, e.g., 2-aminoethylphosphonic acid; organic phosphonic acids, e.g., phenylphosphonic acid, naphthylphosphonic acid, alkyl phosphonic acid, glycerophosphonic acid, methylenediphosphonic acid and ethylenediphosphonic acid, each of which may have a substituent; organic phosphoric acids, e.g., phenylphosphoric acid, naphthylphosphoric acid, alkylphosphoric acid and glycerophosphoric acid, each of which may have a substituent; organic phosphinic acids, e.g., phenylphosphinic acid, naphthylphosphinic acid, alkylphosphinic acid and glycerophosphinic acid, each of which may have a substituent; amino acids, e.g., glycine and β-alanine; and hydrochlorides of amines having a hydroxy group, e.g., hydrochloride of triethanolamine. The compounds may be used as a mixture of two or more thereof.

The organic undercoat layer can be provided by the following methods. Specifically, there are a method of dissolving the above-described organic compound in water, an organic solvent, e.g., methanol, ethanol or methyl ethyl ketone, or a mixed solvent thereof, coating the resulting solution on an aluminum plate and drying it to provide the organic, undercoat layer, and a method of dissolving the organic compound in water, an organic solvent, e.g., methanol, ethanol or methyl ethyl ketone, or a mixed solvent thereof, immersing an aluminum plate in the resulting solution to adsorb the compound, washing the aluminum plate with water or the like, and drying it to provide the organic undercoat layer. In the former method, the solution containing the organic compound in a concentration of 0.005 to 10% by weight can be coated by various methods. In the latter method, the concentration of the solution is from 0.01 to 20% by weight, preferably from 0.05 to 5% by weight, the immersion temperature is from 20 to 90° C., preferably from 25 to 50° C., and the immersion time is from 0.1 second to 20 minutes, preferably from 2 seconds to 1 minute. The solution used may also be adjusted its pH to a range of from 1 to 12 with a basic substance, for example, ammonia, triethylamine or potassium hydroxide or an acidic substance, for example, hydrochloric acid or phosphoric acid. Moreover, a yellow dye may be added to the solution in order to improve the tone reproducibility of the photosensitive layer. The coverage of the organic undercoat layer is suitably from 2 to 200 mg/m², and preferably from 5 to 100 mg/M². When the coverage of the organic undercoat layer is less than 2 mg/m², sufficient printing durability cannot be obtained. When the coverage is more than 200 mg/m², the same problem occurs. In the lithographic printing plate precursor of the invention, a protective layer may be provided on the photosensitive layer, if desired. Examples of the component of the protective layer include polyvinyl alcohol and a matting material used in conventional photosensitive image-forming materials.

The lithographic printing plate precursor prepared as above according to the invention is ordinarily subjected to image exposure and development processing. As a light source of active beam for use in the image exposure according to the invention, a light source having an emission wavelength in the region of from near infrared to infrared of not less than 700 nm is preferred, and a solid laser or a semiconductor laser is particularly preferred.

As a developer and its replenisher used in the development of the lithographic printing plate precursor of the invention, a conventionally known aqueous alkali solution containing an alkali agent can be employed. Examples of the alkali agent include an inorganic alkali salt, for example, sodium silicate, potassium silicate, sodium tertiary phosphate, potassium tertiary phosphate, ammonium tertiary phosphate, sodium secondary phosphate, potassium secondary phosphate, ammonium secondary phosphate, sodium carbonate, potassium carbonate, ammonium carbonate, sodium hydrogen carbonate, potassium hydrogen carbonate, ammonium hydrogen carbonate, sodium borate, potassium borate, ammonium borate, sodium hydroxide, ammonium hydroxide, potassium hydroxide or lithium hydroxide. Also, an organic alkali agent, for example, monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine or pyridine can be used. The alkali agents can be used individually or in combination of two or more thereof. Of the developers containing the alkali agent, an aqueous solution of silicate, for example, sodium silicate or potassium silicate is particularly preferred. The reason for this is that the developability can be controlled by appropriately adjusting a ratio between silicon oxide (SiO₂) and alkali metal oxide (M₂O) as constituents of the silicate and concentration of the silicate. For instance, alkali metal silicates described in JP-A-54-62004 and JP-B-57-7427 can be effectively used.

It is known that in the case of performing the development using an automatic developing machine, by adding an aqueous solution (replenisher) having higher alkalinity than the developer is added to the developer, a large amount of pre-sensitized lithographic printing plates can be processed without exchanging the developer in the development tank for a long period of time. In the invention, such a replenishing system is also preferably used. In the developer and the replenisher, a variety of surfactants and organic-solvents may be added, if desired, for the purpose of accelerating or inhibiting the development, dispersing the development scum, or enhancing the ink-receptivity of the image area of printing plate. Preferred examples of the surfactant include anionic, cationic, nonionic and amphoteric surfactants. Furthermore, the developer or replenisher may contain, if desired, a reducing agent, for example, hydroquinone, resorcin or a sodium salt or potassium salt of an inorganic acid (e.g., sulfurous acid, hydrogen sulfurous acid), an organic carboxylic acid, a defoaming agent and a water softening agent. The lithographic printing plate precursor developed using the above-described developer and replenisher is subjected to an after-treatment with washing water, a rinsing solution containing a surfactant or the like, or a desensitizing solution containing gum arabic or a starch derivative. These treatments can be used in various combinations for the after-treatment of the lithographic printing plate precursor of the invention.

In recent years, an automatic developing machine for printing plates has been widely used in the plate-making and printing industry so as to rationalize and standardize the plate-making operation. In general, the automatic developing machine has a developing part and an after-treatment part and comprises a device for conveying a printing plate precursor, and tanks for respective processing solutions and spraying devices. In the development processing, each processing solution pumped up by a pump is sprayed through spray nozzles to the exposed printing plate precursor while horizontally conveying the printing plate precursor. In recent years, a method of processing a printing plate precursor by immersing the printing plate precursor in processing solution bathes each filled with a processing solution while conveying the printing plate precursor by means of guide rollers in the solution is also known. In such automatic processing, the processing can be performed while replenishing the replenisher to each processing solution in accordance with the amount of processing, the operating time or the like. Furthermore, a so-called disposable processing system of performing the processing using a substantially fresh processing solution can also be employed.

In the case where a lithographic printing plate obtained from the lithographic printing plate precursor of the invention through image exposure, development, water washing and/or rinsing and/or gumming has an unnecessary image area (for example, film edge mark of an original film), elimination of the unnecessary image area is carried out. Such elimination is preferably performed by a method described, for example, in JP-B-2-13293, where a eliminating solution is applied to the unnecessary image area, allowed to stand for a predetermined time and thereafter, washed with water. However, a method described in JP-A-59-174842, where the unnecessary image area is irradiated with an active beam guided by an optical fiber and then subjected to development is also utilized.

The thus-obtained lithographic printing plate is, if desired, coated with a desensitizing gum and then used in a printing step. However, when a lithographic printing plate having higher printing durability is desired, the printing plate is subjected to a burning treatment. In the case of burning the lithographic printing plate, the plate before the burning is preferably treated with a plate burning conditioner described, for example, in JP-B-61-2518, JP-B-55-28062, JP-A-62-31859 and JP-A-61-159655. The treatment may be performed by a method of applying the plate burning conditioner on the lithographic printing plate using a sponge or an absorbent cotton impregnated with the plate burning conditioner, a method of applying the plate burning conditioner by immersing the printing plate in a vat filled with the plate burning conditioner, or a method of applying the plate burning conditioner using an automatic coater. Making the amount of plate burning conditioner applied uniform by a squeegee or a squeegee roller after the application thereof provides more preferred results.

An amount of the plate burning conditioner applied is ordinarily from 0.03 to 0.8 g/m² (dry weight). The lithographic printing plate applied with the plate burning conditioner is dried, if desired, and then heated at a high temperature by a burning processor (for example, a burning processor “BP-1300” commercially available from Fuji Photo Film Co., Ltd.). The heating temperature and the heating time are preferably from 180 to 300° C. and from 1 to 20 minutes, respectively, though these may be varied depending on the components constituting the image.

The lithographic printing plate after the burning treatment can be subjected, if desired, to conventional treatment, for example, water washing and gumming, however, in the case where the plate burning conditioner containing a water-soluble polymer compound or the like is used, a so-called desensitizing treatment, for example, gumming can be omitted. The lithographic printing plate obtained through such treatments is mounted on an offset printing machine and used for printing of a large number of sheets.

The invention will be described in greater detail with reference to the following examples but the invention should not be construed as being limited thereto.

### EXAMPLE 1

(Preparation of Support)

An aluminum plate having g a thickness of 0.24 mm (made of aluminum alloy containing 0.06% by weight of Si, 0.30% by weight of Fe, 0.014% by weight of Cu, 0.001% by weight of Mn, 0.001% by weight of Mg, 0.001% by weight of Zn, 0.03% by weight of Ti, and the balance of Al and unavoidable impurities) was continuously subjected to the surface treatments described below.

Mechanical graining of the aluminum plate was carried out using rotating roller-form nylon brushes while supplying a suspension of abrasive (silica sand) in water having a specific gravity of 1.12 to the surface of the aluminum plate as an abrasive slurry. The aluminum plate was then subjected to an etching treatment by spraying a solution having a sodium hydroxide concentration of 2.6% by weight, an aluminum ion concentration of 6.5% by weight and a temperature of 70° C. to dissolve 6 g/m² of the aluminum plate, followed by washing with water by spraying. Further, the aluminum plate was subjected to a desmut treatment by spraying an aqueous solution having a nitric acid concentration of 1% by weight (containing 0.5% by weight of aluminum ion) and a temperature of 30° C., followed by washing with water by spraying. Then, using an alternating current of 60 Hz, an electrochemical graining treatment was continuously carried out. The electrolyte used was an aqueous solution of 10 g/liter of nitric acid (containing 5 g/liter of aluminum ion and 0.007% by weight of ammonium ion) and the temperature was 80° C. After washing with water, the aluminum plate was subjected to an etching treatment by spraying a solution having a sodium hydroxide concentration of 26% by weight and an aluminum ion concentration of 6.5% by weight at 32° C. to dissolve 0.20 g/m² of the aluminum plate, followed by washing with water by spraying. Then, the aluminum plate was subjected to a desmut treatment by spraying an aqueous solution having a sulfuric acid concentration of 25% by weight (containing 0.5% by weight of aluminum ion) and a temperature of 60° C., followed by washing with water by spraying.

The aluminum plate was then subjected to an anodizing treatment using an anodizing apparatus of a two-stage feeding electrolytic treatment method. As an electrolyte supplied to the electrolytic parts, sulfuric acid was used. Thereafter, washing with water was performed by spraying. The final amount of the oxidized film formed was 2.7 g/m².

The aluminum plate subjected to the anodizing treatment was immersed in an aqueous solution of 1% by weight 3# sodium silicate and a temperature of 30° C. for 10 seconds, whereby an alkali metal silicate treatment (silicate treatment) was carried out. Then, washing with water was performed by spraying.

On the aluminum plate after the silicate treatment obtained above, an undercoat solution having the composition described below was coated, followed by drying at 80° C. for 15 seconds to form an undercoat layer. The coating coverage of the undercoat layer after drying was 15 mg/m².

<Composition of Undercoat Solution>

| | |
|---|---|
| Compound described below | 0.3 g |
| Methanol | 100 g |
| Water | 1 g |
| 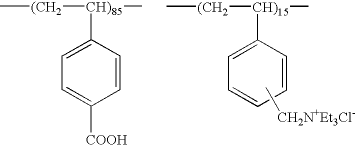 | |
| Molecular weight: 28,000 | |

On the support thus obtained, Coating solution 1 for first layer (lower layer) having the composition shown below was coated so as to have a coated amount of 0.85 g/m² and dried at 140° C. for 50 seconds using PERFECT OVEN PH200 manufactured by TABAI Corp. by setting Wind Control 7. Then, Coating solution 1 for second layer (upper layer) having the composition shown below was coated so as to have a coated amount of 0.22 g/m² and dried at 140° C. for one minute to prepare Lithographic printing plate precursor 1.

(Coating Solution 1 for First Layer)

| | |
|---|---|
| N-(4-Aminosulfonylphenyl)methacryl- | 2.133 g |
| amide/acrylonitrile/methyl methacrylate | |
| copolymer (36/34/30% by weight; weight average | |
| molecular weight: 50,000; acid value: 2.65) | |
| Cyanine dye A (having the structure shown below) | 0.109 g |
| 4,4′-Bishydroxyphenylsulfone | 0.126 g |
| cis-Δ⁴-Tetrahydrophthalic anhydride | 0.190 g |
| p-Toluenesulfonic acid | 0.008 g |
| 3-Methoxy-4-diazodiphenylamine hexafluorophosphate | 0.030 g |
| Compound obtained by replacing | 0.100 g |
| counter ion of Ethyl Violet | |
| with 6-hydroxy-2-naphthalenesulfonate | |
| Megafac F176 (manufactured by DAINIPPON | 0.035 g |
| INK & CHEMICALS, INC.) | |
| (Fluorine-containing surfactant for | |
| improving coated surface state) | |
| Methyl ethyl ketone | 25.38 g |
| Ethanol | 13.0 g |
| γ-Butyrolactone (204° C., 4.12 debye) | 13.2 g |
| 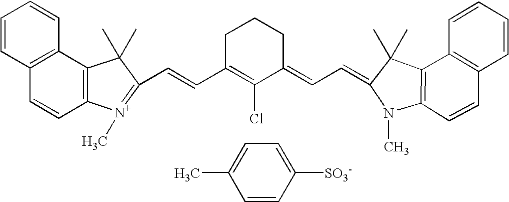 | |
| (Coating solution 1 for second layer) | |
| m,p-Cresol novolak resin (m/p ratio = 6/4; | 0.3479 g |
| weight average molecular weight: 4,500; | |
| containing 0.8% by weight of unreacted cresol) | |
| Cyanine dye A (having the structure shown above) | 0.0192 g |
| Ethyl methacrylate/isobutyl methacrylate/ | 0.1403 g |
| acrylic acid copolymer (37/37/26% by weight) | |
| (as 30% by weight MEK solution) | |
| Megafac F176 (20%) (manufactured by | 0.022 g |
| DAINIPPON INK & CHEMICALS, INC.) | |
| (Surfactant for improving coated surface state) | |
| Megafac MCF-312 (30%) (manufactured by | 0.011 g |
| DAINIPPON INK & CHEMICALS, INC.) | |
| Methyl ethyl ketone | 13.07 g |
| Ethanol | 6.79 g |

(Evaluations of Amount of Remaining Solvent and Sensitivity)

Sensitivity of the lithographic printing plate precursor thus obtained according to the invention was determined in the following manner.

A solid image was drawn on the lithographic printing plate precursor at a beam intensity raging from 2 to 10 W and a drum rotation speed of 150 rpm using Trendsetter manufactured by Creo Inc. The exposed lithographic printing plate precursor was developed using PS Processor LP940H manufactured by Fuji Photo film Co., Ltd., to which a developing solution prepared by diluting a developer DT-2 manufactured by Fuji Photo film Co., Ltd. in a ratio of 1:8 and a solution prepared by diluting Finisher FG-1 manufactured by Fuji Photo film Co., Ltd. in a ratio of 1:1 had been charged, at a solution temperature of 30° C. for a developing time of 12 seconds. The electric conductivity of the developing solution was 43 mS/cm.

The printing plate obtained after development was observed by a loupe of 25 magnifications to evaluate the presence of residual film on the printing plate, and the printing plate on which the residual film present was in a level of causing substantially no printing stain was determined. From the beam intensity used for the exposure to form the printing plate, a practical exposure energy was calculated and defined as the sensitivity. Further, a weight of the lithographic printing plate precursor after coating and drying the photosensitive layer and a weight of the lithographic printing plate precursor after being subjected to drying at a reduced pressure of 0.5 mmHg and a temperature of 40° C. for 24 hours for the purpose of substantially removing the remaining solvent were measured, and from a decreased amount of the weight, a weight % of the remaining solvent in the photosensitive layer was determined. The results obtained are shown in Table 1 below.

TABLE 1

| | Remaining Solvent | Sensitivity |
|---|---|---|
| | (wt %) | (mJ/cm²) |
| Example 1 | 2.2 | 98 |

### EXAMPLES 2 TO 7 AND COMPARATIVE EXAMPLES 1 TO 3

Coating solutions 2 to 7 for first layer were prepared in the same manner as in Coating solution 1 for first layer described in Example 1 except for using 1,3-dimethyl-2-imidazolidinone (225.5° C., 4.05-4.09 debye), N,N-dimethylformamide (153° C., 3.86 debye), tetramethylurea (175-177° C., 3.92 debye), N-methylpyrrolidone (202° C., 4.09 debye), N,N-dimethylacetamide (166° C., 3.72 debye) and dimethylsulfoxide (189° C., 4.3 debye) in place of γ-butyrolactone used in Coating solution 1 for first layer described in Example 1, respectively. Lithographic printing plate precursors were prepared using Coating solutions 2 to 7 for first layer and evaluated in the same manner as in Example 1. Thus, the results shown in Table 2 were obtained.

Further, for comparison, it was attempted to prepare coating solutions for first layer in the same manner as in Coating solution 1 for first layer described in Example 1 except for eliminating γ-butyrolactone and increasing the amount of ethanol or methyl ethyl ketone so as to compensate the amount of γ-butyrolactone. However, the components of the composition did not sufficiently dissolved and lithographic printing plate precursors could not be prepared.

Moreover, as Comparative Example 3, a lithographic printing plate precursor was prepared in the same manner as in Example 1 except for changing the drying condition for the first layer from 140° C. for 50 seconds to 180° C. for 2 minutes and evaluated in the same manner as in Example 1. The results are shown in Table 2 below.

TABLE 2

| | Solvent of Coating | | |
|---|---|---|---|
| | Solution for First | | |
| | Layer | Remaining | |
| | (boiling point and | Solvent | Sensitivity |
| | dipole moment) | (wt %) | (mJ/cm²) |
| Example 2 | 1,3-Dimethyl-2- | 4.3 | 90 |
| | imidazolidinone | | |
| | (225.5° C., 4.05-4.09 | | |
| | debye) | | |
| Example 3 | N,N- | 2.5 | 100 |
| | Dimethylformamide | | |
| | (153° C., 3.86 | | |
| | debye) | | |
| Example 4 | Tetramethylurea | 2.6 | 98 |
| | (175-177° C., 3.92 | | |
| | debye) | | |
| Example 5 | N- | 4.0 | 90 |
| | Methylpyrrolidone | | |
| | (202° C., 4.09 | | |
| | debye) | | |
| Example 6 | N,N- | 2.3 | 98 |
| | Dimethylacetamide | | |
| | (166° C., 3.72 | | |
| | debye) | | |
| Example 7 | Dimethylsulfoxide | 4.1 | 90 |
| | (189° C., 4.3 debye) | | |
| Comparative | Ethanol | Not evaluated because of | |
| Example 1 | (78.3° C., 1.44 | incomplete dissolution of | |
| | debye) | components | |
| Comparative | Methyl ethyl | Not evaluated because of | |
| Example 2 | ketone | incomplete dissolution of | |
| | (80° C., 2.76 debye) | components | |
| Comparative | γ-Butyrolactone | 0.2 | 130 |
| Example 3 | (204° C., 4.12 | | |
| | debye) | | |

According to the lithographic printing plate precursor of the invention, the effects of excellent chemical resistance, good handling property in the production and high sensitivity can be achieved.

The entire disclosure of each and every foreign patent application from which the benefit of foreign priority has been claimed in the present application is incorporated herein by reference, as if fully set forth herein.

While the invention has been described in detail and with reference to specific embodiments thereof, it will be apparent to one skilled in the art that various changes and modifications can be made therein without departing from the spirit and scope thereof.

What is claimed is:

1. A lithographic printing plate precursor comprising a hydrophilic support having provided thereon a first layer comprising a first resin that is water-insoluble and alkali-soluble and a second layer comprising a second resin that is water-insoluble and alkali-soluble in this order and a light-heat converting agent incorporated into at least one layer of the first layer and second layer, which further comprises at least one organic solvent selected from organic solvents having a boiling point not less than 150° C. and a dipole moment not less than 3.50 debye in an amount of from 0.5 to 5% by weight based on the total dry weight of the first layer and second layer.

2. A method for the preparation of a lithographic printing plate precursor comprising applying a first layer comprising a first resin that is water-insoluble and alkali-soluble with a coating solvent containing at least one organic solvent selected from organic solvents having a boiling point not less than 150° C. and a dipole moment not less than 3.50 debye and then applying a second layer comprising a second resin that is water-insoluble and alkali-soluble with a solvent having a boiling point less than 150° C. that does not contain the organic solvent having a boiling point not less than 150° C. and a dipole moment not less than 3.50 debye used for the application of the first layer.
